(19) United States
(12) Patent Application Publication
(10) Pub. No.: US 2012/0306879 A1
(43) Pub. Date: Dec. 6, 2012

(54) INFORMATION PROCESSING APPARATUS, INFORMATION PROCESSING METHOD, AND PROGRAM

(75) Inventor: Kenji YOKOYAMA, Tokyo (JP)

(73) Assignee: SONY CORPORATION, Tokyo (JP)

(21) Appl. No.: 13/479,771

(22) Filed: May 24, 2012

(30) Foreign Application Priority Data
Jun. 6, 2011 (JP) 2011-126469

(51) Int. Cl. G06T 17/00

(52) U.S. Cl. 345/428

(57) ABSTRACT

An apparatus includes a display control unit configured to control a display unit to display content including a plurality of images and an adjustment bar having a slider that controls a current image of the content displayed on the display unit. The slider is moved by a first operation and a second operation. The second operation changes a position of the slider with a finer adjustment than the first operation.

### CROSS-REFERENCE TO RELATED APPLICATIONS

The present application is based upon and claims the benefit of priority under 35 U.S.C. §119 of Japanese Priority Patent Application JP 2011-126469 filed in the Japanese Patent Office on Jun. 6, 2011, the entire contents of which are hereby incorporated by reference.

### BACKGROUND

The present disclosure relates to an information processing apparatus, an information processing method, and a program encoded on a non-transitory computer readable medium.

In an operation screen for playing back content, there is used an adjustment bar which relatively indicates a current value of a predetermined parameter with respect to a full amount which the parameter may take, using the position of a slider on a bar. In the adjustment bar, the position of the slider is operated, and thus, the current value of the parameter is changed. For example, the adjustment bar indicating a playback position is referred to as seek bar. The seek bar indicates the playback position of content, and is also used for changing the playback position of the content by operating the position of the slider (for example, see JP 2004-140552A).

### SUMMARY

However, it is difficult to make a fine adjustment in the operation of setting the current value using the adjustment bar. In light of the foregoing, it is desirable to provide an information processing apparatus, an information processing method, and a program encoded on a non-transitory computer readable medium which are novel and improved, and which are capable of easily making a fine adjustment to the current value.

Accordingly, the present invention broadly comprises an apparatus, a method, and a non-transitory computer readable medium encoded with a program which causes the processor to perform the method. In one embodiment, the apparatus includes a display control unit configured to control a display unit to display content including a plurality of images and an adjustment bar having a slider that controls a current image of the content displayed on the display unit. The slider is moved by a first operation and a second operation. The second operation changes a position of the slider with a finer adjustment than the first operation.

### BRIEF DESCRIPTION OF THE DRAWINGS

FIG. 1 is an external view of an information processing apparatus according to an embodiment of the present disclosure;

FIG. 2 is a functional block diagram of the information processing apparatus according to the embodiment;

FIG. 3 is a block diagram showing an example of a hardware configuration of the information processing apparatus according to the embodiment;

FIG. 4 is an explanatory diagram illustrating an example of a display screen provided by the information processing apparatus according to the embodiment;

FIG. 5 is an explanatory diagram illustrating another example of the display screen provided by the information processing apparatus according to the embodiment;

FIG. 6 is an explanatory diagram showing an example of a first operation performed to an adjustment bar displayed by the information processing apparatus according to the embodiment;

FIG. 7 is an explanatory diagram showing another example of the first operation performed to the adjustment bar displayed by the information processing apparatus according to the embodiment;

FIG. 8 is an explanatory diagram illustrating an action at an end part of the adjustment bar displayed by the information processing apparatus according to the embodiment;

FIG. 9 is an explanatory diagram illustrating an example of a shape and variations in the shape of the adjustment bar displayed by the information processing apparatus according to the embodiment;

FIG. 10 is an explanatory diagram showing another example of the shape of the adjustment bar displayed by the information processing apparatus according to the embodiment;

FIG. 11 is an explanatory diagram showing schematically a second operation performed to the adjustment bar displayed by the information processing apparatus according to the embodiment and a motion of the adjustment bar on that occasion;

FIG. 12 is an explanatory diagram illustrating a rightward fine adjustment operation performed to the adjustment bar displayed by the information processing apparatus according to the embodiment;

FIG. 13 is an explanatory diagram illustrating a leftward fine adjustment operation performed to the adjustment bar displayed by the information processing apparatus according to the embodiment;

FIG. 14 is an explanatory diagram illustrating an action executed when a flick operation is performed to the adjustment bar displayed by the information processing apparatus according to the embodiment;

FIG. 15 is an explanatory diagram showing an example of an operation area in which a fine adjustment operation performed to the adjustment bar is detected, the adjustment bar being displayed by the information processing apparatus according to the embodiment;

FIG. 16 is an explanatory diagram showing another example of the operation area in which the fine adjustment operation performed to the adjustment bar is detected, the adjustment bar being displayed by the information processing apparatus according to the embodiment;

FIG. 17 is an explanatory diagram showing another example of the operation area in which the fine adjustment operation performed to the adjustment bar is detected, the adjustment bar being displayed by the information processing apparatus according to the embodiment;

FIG. 18 is an explanatory diagram showing an example of a display to be displayed in the operation area for the fine adjustment operation of the adjustment bar displayed by the information processing apparatus according to the embodiment; and

FIG. 19 is an explanatory diagram showing an example of a display to be displayed in the operation area for the fine adjustment operation of the adjustment bar displayed by the information processing apparatus according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Configuration of information processing apparatus according to an embodiment of the present disclosure

2. Example of user interface according to the embodiment
2-1. Examples of screen layout
2-2. Basic operations of adjustment bar
2-3. Examples of action in fine adjustment operation
2-4. Examples of operation area in which fine adjustment operation is detected

3. Conclusion

<1. Configuration of Information Processing Apparatus According to an Embodiment of the Present Disclosure>

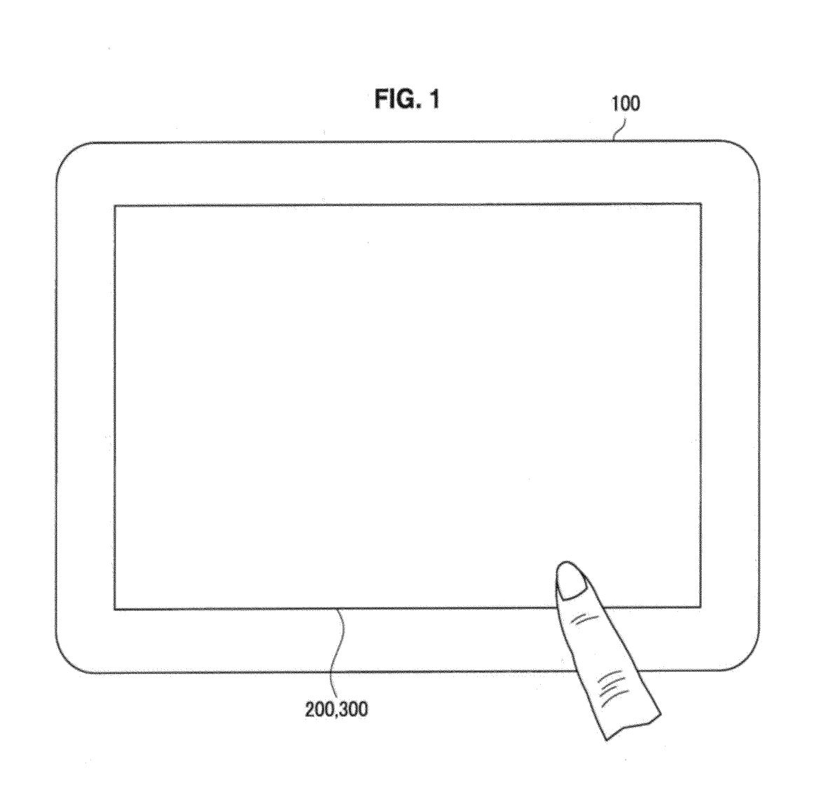

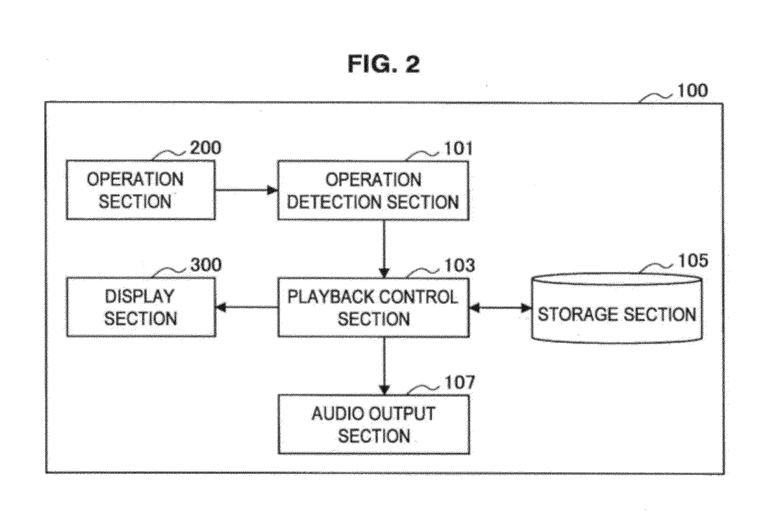

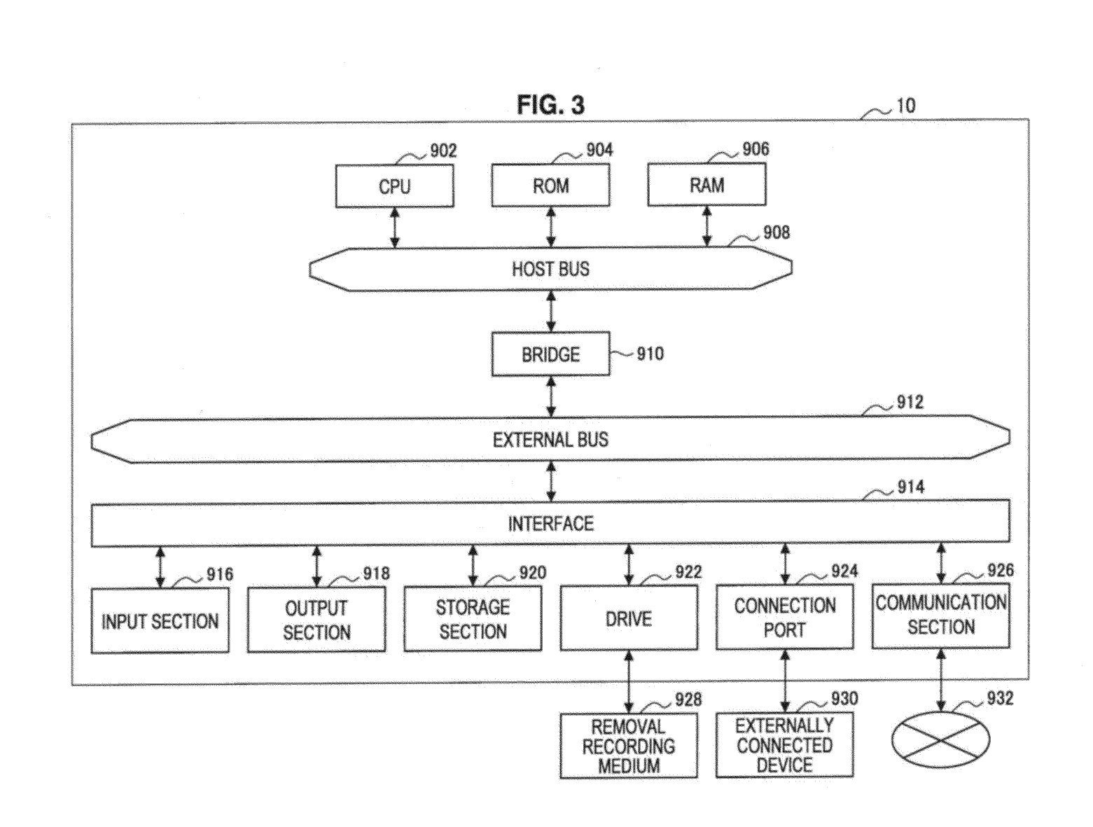

First, with reference to FIGS. 1 to 3, a configuration of an information processing apparatus according to an embodiment of the present disclosure will be described. FIG. 1 is an external view of an information processing apparatus according to an embodiment of the present disclosure. FIG. 2 is a functional block diagram of the information processing apparatus according to the embodiment. FIG. 3 is a block diagram showing an example of a hardware configuration of the information processing apparatus according to the embodiment.

An information processing apparatus 100 according to the present embodiment is an apparatus which is capable of performing an input operation using a touch sensor. The information processing apparatus 100 may be an apparatus such as a mobile phone including a smartphone, and may also be an apparatus such as a mobile music playback device, a mobile video processing device, a mobile game console, a PC (Personal Computer), a PHS (Personal Handyphone System), and a PDA (Personal Digital Assistant).

Referring to FIG. 1, a display section 300 is provided on the surface of the information processing apparatus 100. Superimposed on the display section 300 is an operation section 200 formed of a touch sensor. Further, although not shown, the information processing apparatus 100 may have the operation section 200 formed of a button or the like, in addition to the touch sensor. A user can input desired operation information to the information processing apparatus 100 by operating a display screen displayed on the display section 300 by using an operating object such as a finger and a stylus pen. Further, the information processing apparatus 100 can control the contents of the display screen based on the input operation information. For example, the information processing apparatus 100 can control the contents of the display screen using a so-called GUI (Graphical User Interface).

Next, referring to FIG. 2, an example of the functional configuration of the information processing apparatus 100 according to the present embodiment is shown. The information processing apparatus 100 includes the operation section 200, the display section 300, an operation detection section 101, a playback control section 103, a storage section 105, and an audio output section 107.

The operation section 200 can be configured from, for example, operation means for inputting information by a user, such as a touch sensor, a button, an imaging device, a microphone, a switch, and a lever, and an input control circuit which generates an input signal based on the operation performed by the user and outputs the generated input signal to the operation detection section 101. Here, in the case where the operation section 200 is a touch sensor, the touch sensor to be used may be a contact type touch sensor which detects a position of an operating object touching the screen. Alternatively, there may be used a non-contact touch sensor which detects the position of the operating object above the screen.

The display section 300 may be a display device such as a liquid crystal display (LCD) device or an organic EL (organic light emitting diode (OLED)) display device. The display section 300 operates in accordance with the control of the playback control section 103, and thereby being able to provide the user with the display screen.

The operation detection section 101 has a function of detecting an operation input by the user based on the input operation input from the operation section 200. For example, the operation detection section 101 can detect the operation performed by the user to the display screen which is generated by the function of a display control section that the playback control section 103 has. In this case, the operation detection section 101 can detect an operation performed to an object such as a button or an image displayed on the display screen, for example. Further, the operation detection section 101 can also detect an operation permitted to the display screen regardless of the object displayed on the display screen. Examples of the operation permitted to the display screen regardless of the object include a scaling operation using pinch-close and pinch-open, and a scroll operation. The operation detection section 101 can input operation information including the type of the detected operation, the operation position, and the like to the playback control section 103. In the present embodiment, the operation detection section 101 can detect a first operation of specifying a position of a slider of an adjustment bar. Further, the operation detection section 101 can detect a second operation which has a different motion from that of the first operation. Here, the second operation is an operation for adjusting a current value of a parameter on the basis of a second adjustment unit, which is finer than a first adjustment unit of the first operation.

The playback control section 103 is an example of the display control section, an audio output control section, and an adjustment section. The playback control section 103 can provide the user with content by controlling the display section 300 and the audio output section 107, based on the procedure written in a program for controlling the playback of the content and the operation information input from the operation detection section 101. In the present embodiment, the playback control section 103 can control the display of the display screen including an adjustment bar which relatively indicates a current value of a predetermined parameter with respect to a full amount which the parameter may take, using the position of a slider on a bar. The playback control section 103 adjusts the current value of the parameter indicated by the slider in accordance with the first operation of specifying the position of the slider, and can also change the position of the slider in the display screen based on the adjusted current value of the parameter. Further, the playback control section 103 makes a fine adjustment to the current value of the parameter indicated by the slider on the basis of a unit finer than the unit of the adjustment of the first operation, in accordance with the second operation, and can also change the position of the slider in the display screen based on the adjusted current value of the parameter. The contents of the display screen and the action of the playback control section 103 corresponding to the operation performed to the display screen will be described in detail below.

The storage section 105 is a device for storing data, and can include a storage medium, a recording device for recording data in the storage medium, a reading device for reading out the data from the storage medium, and a deletion device for deleting the data recorded in the storage medium. Examples of the storage medium used here may include a non-volatile memory such as a flash memory, an MRAM (Magnetoresistive Random Access Memory), a FeRAM (Ferroelectric Random Access Memory), a PRAM (Phase change Random Access Memory), and an EEPROM (Electronically Erasable and Programmable Read Only Memory), and a magnetic recording medium such an HDD (Hard Disk Drive). The storage section 105 can store a program for controlling an action of the information processing apparatus 100 and various types of data, for example. For example, the storage section 105 can also store content to be played back by the playback control section 103.

The audio output section 107 is a device which outputs audio. The audio output section 107 can output audio in accordance with the control of the playback control section 103, for example. The audio output section 107 may include, for example, a decoder for decoding audio data, a D/A (Digital/Analog) converter for converting digital data into analog data, and a speaker for outputting an audio signal. The audio output section 107 can output the audio signal specified by the playback control section 103 at a volume specified by the playback control section 103.

Heretofore, an example of the functional configuration of the information processing apparatus 100 according to the present embodiment has been shown. Each of the above structural elements may be configured using general-purpose members or circuits, or may be configured using hardware specialized for the function of each structural element. Further, the function of each structural element may be realized by reading out, by an arithmetic unit such as a CPU (Central Processing Unit), a control program from the storage medium such as a ROM (Read Only Memory) or a RAM (Random Access Memory) that stores the control program in which procedures for realizing those functions are written, and by interpreting and executing the program. Therefore, the configuration to be used can be changed appropriately in accordance with the technical level each time when the embodiment is carried out.

Note that there may be produced a computer program for realizing each function of the information processing apparatus 100 according to the present embodiment as described above, and the computer program can be implemented in a personal computer or the like. Further, there can also be provided a non-transitory computer-readable recording medium having the computer program stored therein. Examples of the non-transitory recording medium include a magnetic disk, an optical disc, a magneto-optical disk, and a flash memory. Further, the computer program may be distributed via a network, without using the recording medium, for example.

Here, with reference to FIG. 3, an example of a hardware configuration of the information processing apparatus 100 according to the present embodiment will be described. Note that, as described above, the configuration of the information processing apparatus 100 to be used can be changed appropriately in accordance with the technical level each time when the embodiment is carried out, and the hardware configuration to be shown here is an example. The information processing apparatus 100 may have a configuration in which a part of the configuration shown in FIG. 3 is omitted. Further, the information processing apparatus 100 may further have a structural element that is not included in FIG. 3. Alternatively, it is needless to say that the information processing apparatus 100 may have a configuration in which a part of the configuration shown in FIG. 3 is replaced with another structural element.

Referring to FIG. 3, the hardware includes a CPU 902, a ROM 904, a RAM 906, a host bus 908, and a bridge 910. In addition, the hardware includes an external bus 912, an interface 914, an input section 916, an output section 918, a storage section 920, a drive 922, a connection port 924, and a communication section 926. The term CPU is an abbreviation for “Central Processing Unit”. Further, the term ROM is an abbreviation for “Read Only Memory”. In addition, the term RAM is an abbreviation for “Random Access Memory”.

The CPU 902 functions as an arithmetic processing unit or a control unit, for example, and controls entire operation or a part of the operation of each structural element based on various programs recorded on the ROM 904, the RAM 906, the storage section 920, or a removable recording medium 928. The ROM 904 is means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

Those structural elements are connected to each other by, for example, the host bus 908 capable of performing high-speed data transmission. On the other hand, the host bus 908 is connected through the bridge 910 to the external bus 912 whose data transmission speed is relatively low, for example. Further, the input section 916 is, for example, a mouse, a keyboard, a touch panel, a button, a switch, or a lever. Also, the input section 916 may be a remote control that can transmit a control signal by using an infrared ray or other radio waves.

The output section 918 is, for example, a display device such as a CRT, an LCD, a PDP or an ELD, an audio output device such as a speaker or headphones, a printer, a mobile phone, or a facsimile, that can visually or auditorily notify a user of acquired information. The term CRT is an abbreviation for “Cathode Ray Tube”. Further, the term LCD is an abbreviation for “Liquid Crystal Display”. Still further, the term PDP is an abbreviation for “Plasma Display Panel”. In addition, the term ELD is an abbreviation for “Electro-Luminescence Display”.

The storage section 920 is a device for storing various types of data. The storage section 920 is, for example, a magnetic storage device such as a hard disk drive (HDD), a semiconductor storage device, an optical storage device, or a magneto-optical storage device. The term HDD is an abbreviation for “Hard Disk Drive”.

The drive 922 is a device that reads information recorded on the removable recording medium 928 such as a magnetic disk, an optical disc, a magneto-optical disk or a semiconductor memory, or writes information in the removable recording medium 928. The removable recording medium 928 is, for example, a DVD medium, a Blu-ray medium, an HD-DVD medium, various types of semiconductor storage media, or the like. Of course, the removable recording medium 928 may be, for example, an IC card on which a non-contact IC chip is mounted or an electronic device. The term IC is an abbreviation for “Integrated Circuit”.

The connection port 924 is a port such as a USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. The term USB is an abbreviation for “Universal Serial Bus”. Further, the term SCSI is an abbreviation for “Small Computer System Interface”.

The communication section 926 is a communication device to be connected to the network 932, and is, for example, a communication card for a wired or wireless LAN, Bluetooth (registered trademark), or WUSB, an optical communication router, an ADSL router, or various communication modems. The network 932 connected to the communication section 926 is configured from a wire-connected or wirelessly connected network, and is the Internet, a home-use LAN, infrared communication, visible light communication, broadcasting, or satellite communication, for example. The term LAN is an abbreviation for “Local Area Network”. Further, the term WUSB is an abbreviation for “Wireless USB”. In addition, the term ADSL is an abbreviation for “Asymmetric Digital Subscriber Line”.

<2. Example of User Interface According to the Embodiment>

Here, a user interface provided by the information processing apparatus 100 according to the present embodiment will be described. The information processing apparatus 100 according to the present embodiment relates to an operation performed to an adjustment bar including a seek bar and a volume adjustment bar, and to a change of a display screen on this occasion. The information processing apparatus 100 can make a fine adjustment to a position of a slider on the adjustment bar. Accordingly, here, there will be described first an example of an entire layout of a screen including the adjustment bar, and next, there will be described an example of a basic operation of the adjustment bar. After that, with regard to the fine adjustment of the position of the slider, there will be described sequentially a fine adjustment operation and an action of the information processing apparatus 100 on that occasion, and an example of an operation area in which the fine adjustment operation is detected.

(2-1. Examples of Screen Layout)

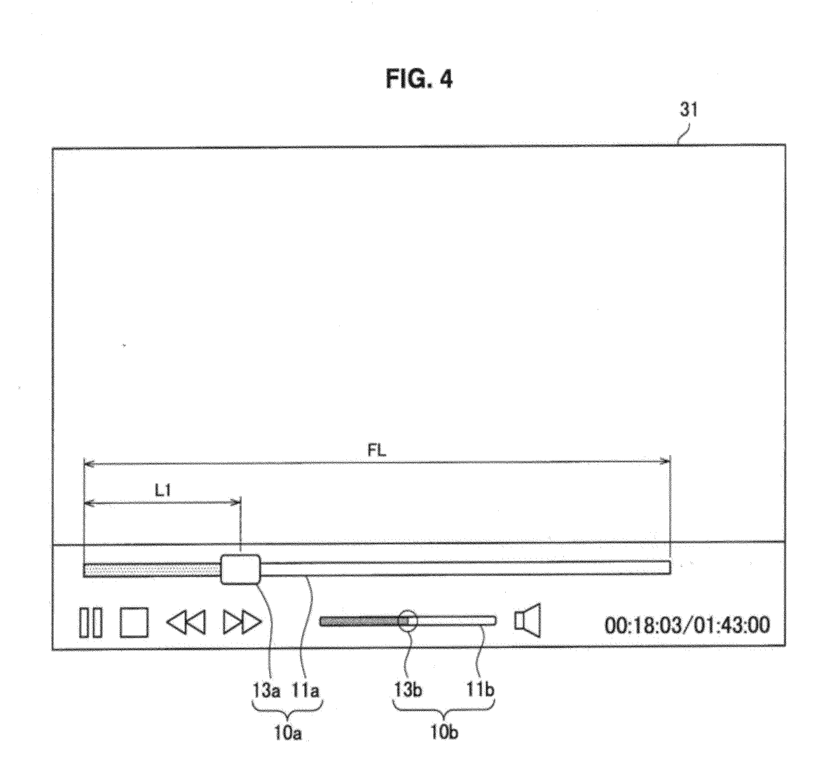

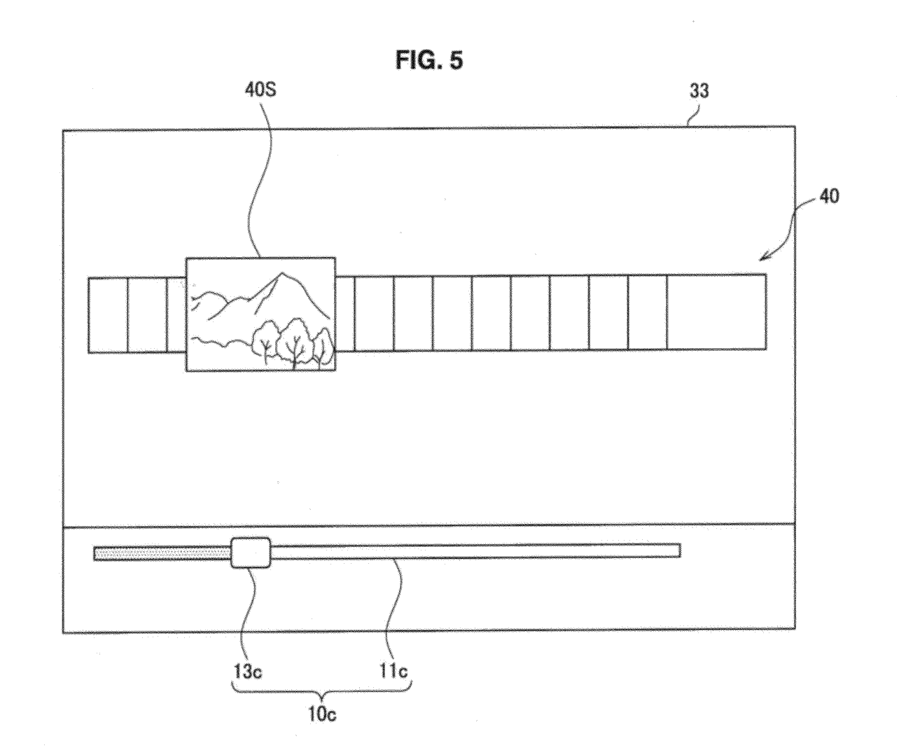

First, with reference to FIG. 4 and FIG. 5, layout examples of the display screen provided by the information processing apparatus 100 according to an embodiment of the present disclosure will be described. FIG. 4 is an explanatory diagram illustrating an example of a display screen provided by the information processing apparatus according to the embodiment. FIG. 5 is an explanatory diagram illustrating another example of the display screen provided by the information processing apparatus according to the embodiment.

Note that, in this specification and the appended drawings, there are some cases where multiple structural elements that have substantially the same function and structure are distinguished from one another by being denoted with different letters after the same reference numerals. For example, the multiple structural elements that have substantially the same function and structure are distinguished from one another as necessary, like an adjustment bar 10a and an adjustment bar 10b. However, in the case where it is not necessary to distinguish the multiple structural elements that have substantially the same function and structure from one another, the multiple structural elements are denoted with the same reference numeral only. For example, in the case where it is not particularly necessary to distinguish the adjustment bar 10a, the adjustment bar 10b, and the like from one another, they are each simply referred to as adjustment bar 10.

First, referring to FIG. 4, there is shown a moving image content playback screen 31 which is an example of the display screen provided by the information processing apparatus 100. The moving image content playback screen 31 includes an operation area for performing operations of content playback start, stop, pause, fast-forward, and fast-rewind, an adjustment bar 10a which is a seek bar for displaying a playback position of content and also for operating the playback position of the content, and an adjustment bar 10b which is a volume adjustment bar for displaying a playback volume of the content and also operating the playback volume of the content. Further, the moving image content playback screen 31 may show the current playback position with respect to the full length of the content being played back in figures. According to the example shown in FIG. 4, the content played back by the moving image content playback screen 31 has a full length of 1 hour 43 minutes, and the current playback position of the content is 18 minutes 3 seconds.

Further, the adjustment bar 10a includes a bar 11a and a slider 13a. The position of the slider 13a with respect to a full length FL of the bar 11a represents relatively the current playback position with respect to the full length of the content. Specifically, the slider 13a is displayed at the position at which the ratio of a length L1, which indicates the length from the left end of the bar 11a to the slider 13a, to the full length FL of the bar 11a becomes equal to the ratio of the current playback position 18 minutes 3 seconds to the content full length 1 hour 43 minutes.

The adjustment bar 10b, which is the volume adjustment bar, can show the current value of volume by making the color of the part from the left end of the bar 11b to the current value of volume different from the rest of the bar 11b. The slider 13b of the adjustment bar 10b is the boundary of colors. Accordingly, the concept of the slider 13 is a part indicating the current value, and may not necessarily be expressed as a member such as the slider 13a.

Further, referring to FIG. 5, there is shown a still image display screen 33 which is an example of the display screen provided by the information processing apparatus 100. The still image display screen 33 can include multiple images 40. Further, the still image display screen 33 can change a selection image 40S, which is being selected from the multiple images 40, in accordance with an operation performed to the adjustment bar 10c. For example, in the still image display screen 33, the selection image 40S among the multiple images 40 is displayed such that the selection image 40S is larger than the other images 40 and is in front of the other images 40. A user operates the adjustment bar 10c, and thus can change the selection image 40S.

Heretofore, there have been described the display screens provided by the information processing apparatus 100 by way of two examples, the moving image content playback screen 31 and the still image display screen 33. However, the present technology is not limited to such examples. For example, content to be played back by the playback control section 103 of the information processing apparatus 100 is not limited to the image content, and may also be audio content. In this case, the audio content is a concept including audio data such as music, a lecture, and a radio program. Further, the image content is a concept including image data such as a television program, a video program, a photograph, a document, a picture, and a chart.

(2-2. Basic Operations of Adjustment Bar)

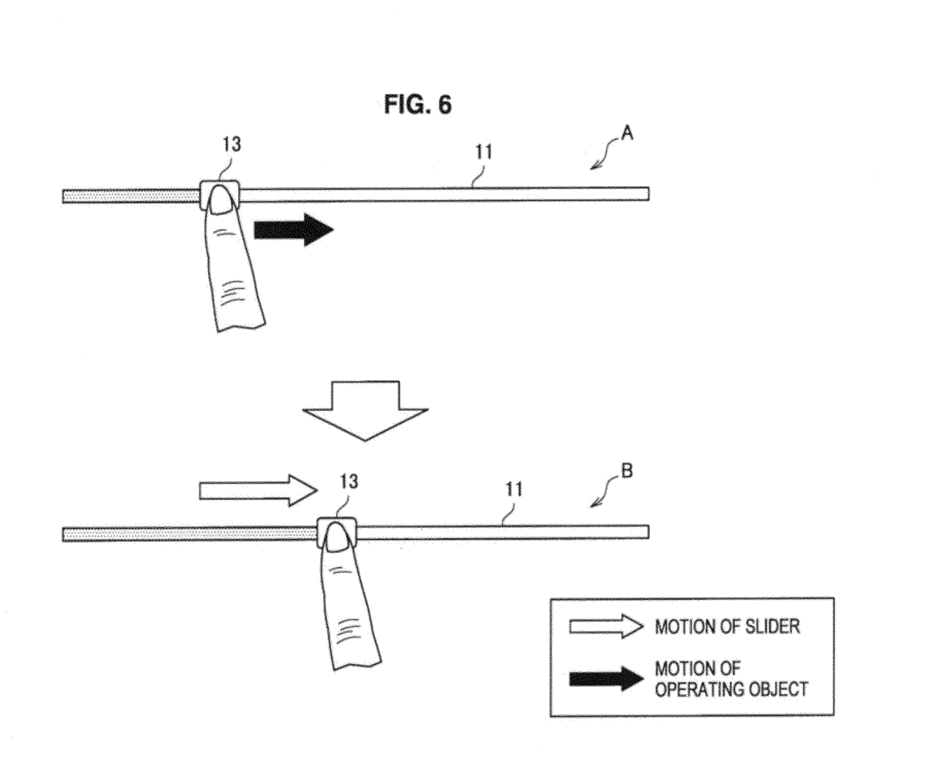

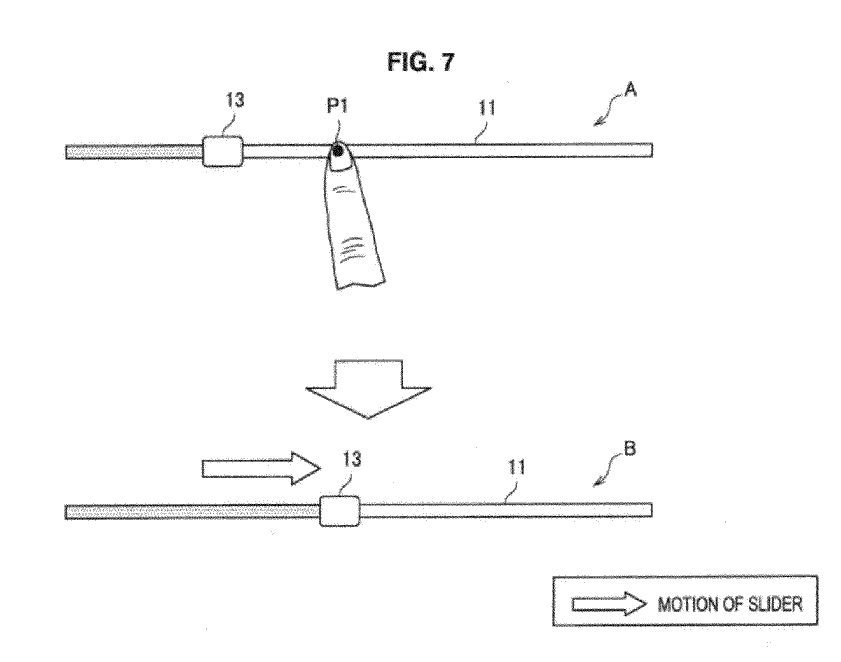

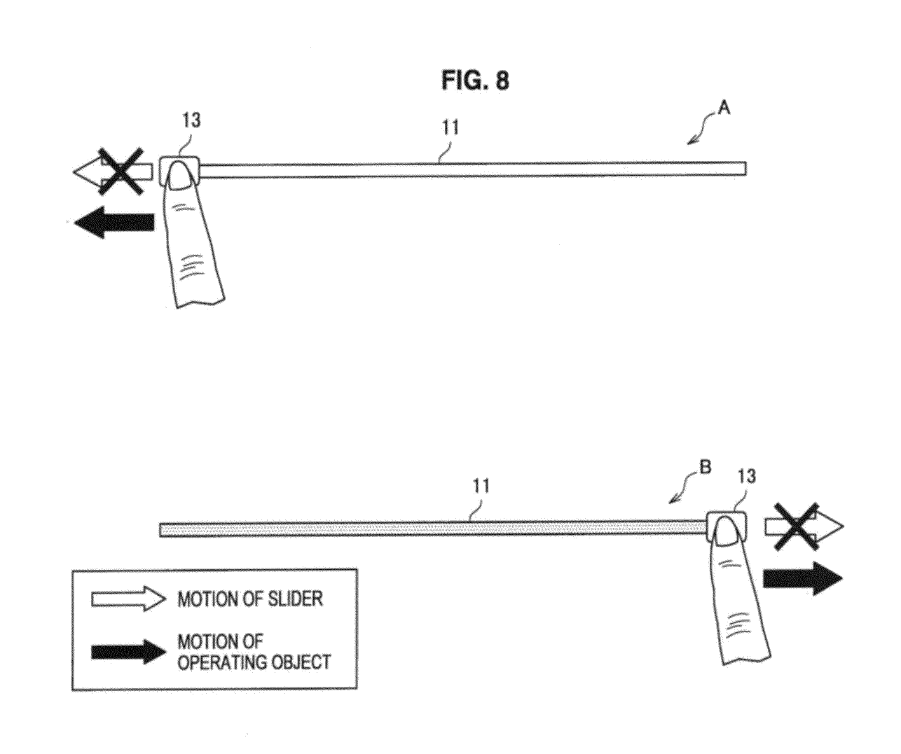

Here, with reference to FIGS. 6 to 8, there will be described basic operations of the adjustment bar 10 included in the display screen of the information processing apparatus 100 according to an embodiment of the present disclosure. FIG. 6 is an explanatory diagram showing an example of a first operation performed to an adjustment bar displayed by the information processing apparatus according to the embodiment. FIG. 7 is an explanatory diagram showing another example of the first operation performed to the adjustment bar displayed by the information processing apparatus according to the embodiment. FIG. 8 is an explanatory diagram illustrating an action at an end part of the adjustment bar displayed by the information processing apparatus according to the embodiment.

For example, on the adjustment bar 10, the position of the slider 13 is changed by a first operation of specifying a position of the slider. FIG. 6 shows an example of the first operation. As shown in A of FIG. 6, when the user places his/her finger on the slider 13 of the display screen, the slider 13 comes into a state of being selected. Then, in the state in which the slider 13 is being selected, when the user performs an action of sliding laterally his/her finger without releasing therefrom (so-called drag operation), the position of the slider 13 is changed in a manner that the position of the slider 13 follows the sliding finger as shown in B of FIG. 6. In this case, a first adjustment unit of the first operation depends on the position detection accuracy of the touch sensor and the size of the display device displaying the adjustment bar 10. As the size of the display device displaying the adjustment bar 10 is smaller, it is difficult to precisely detect the contact position, and the first adjustment unit becomes large (i.e., it is difficult to make a fine adjustment).

Further, FIG. 7 shows another example of the first operation. As shown in A of FIG. 7, the user performs an operation (e.g., double tapping) of specifying a point P1 on the bar 11 of the display screen. Then, as shown in B of FIG. 7, the slider 13 slides to the specified point P1, and thus, the position is changed.

Further, in such an adjustment bar 10, the slider 13 isn't moved beyond an end part of the bar 11. For example, as shown in A of FIG. 8, even if an operation of sliding the finger further to the left is performed at the left end of the bar 11, the slider 13 does not move to the left of the left end of the bar 11. Further, for example, as shown in B of FIG. 8, even if an operation of sliding the finger further to the right is performed at the right end of the bar 11, the slider 13 does not move to the right of the right end of the bar 11.

(2-3. Examples of Actions in Fine Adjustment Operation)

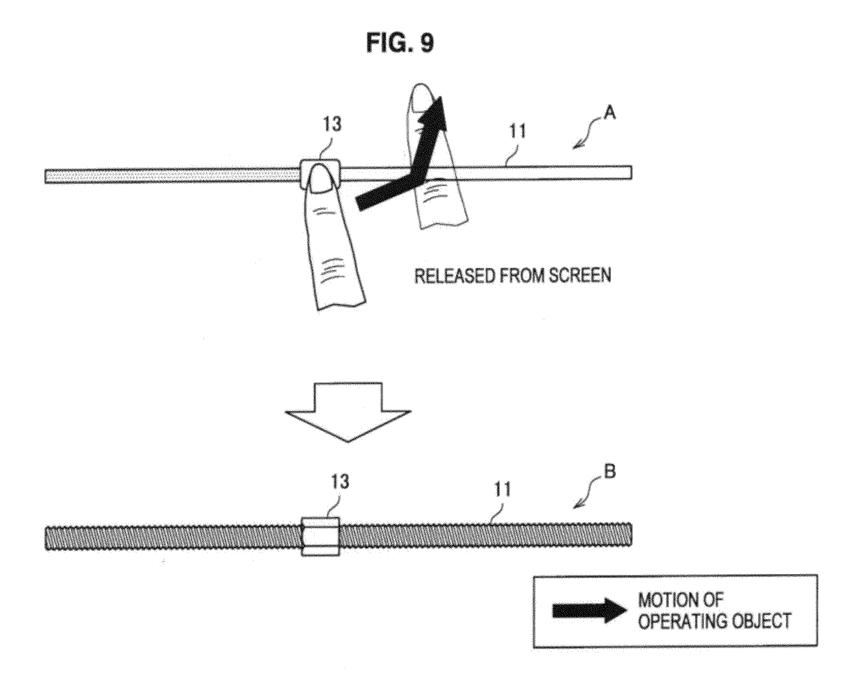

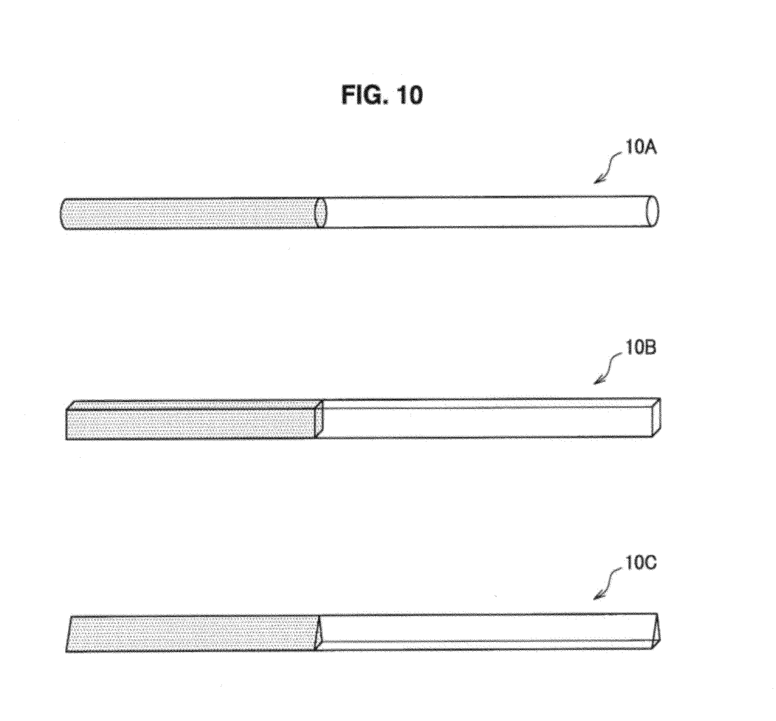

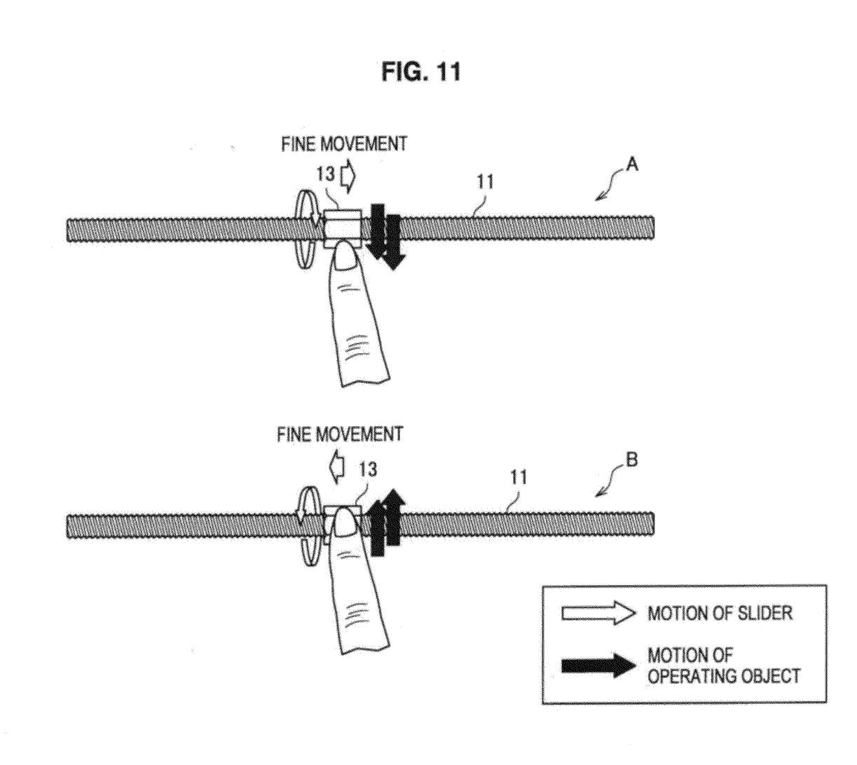

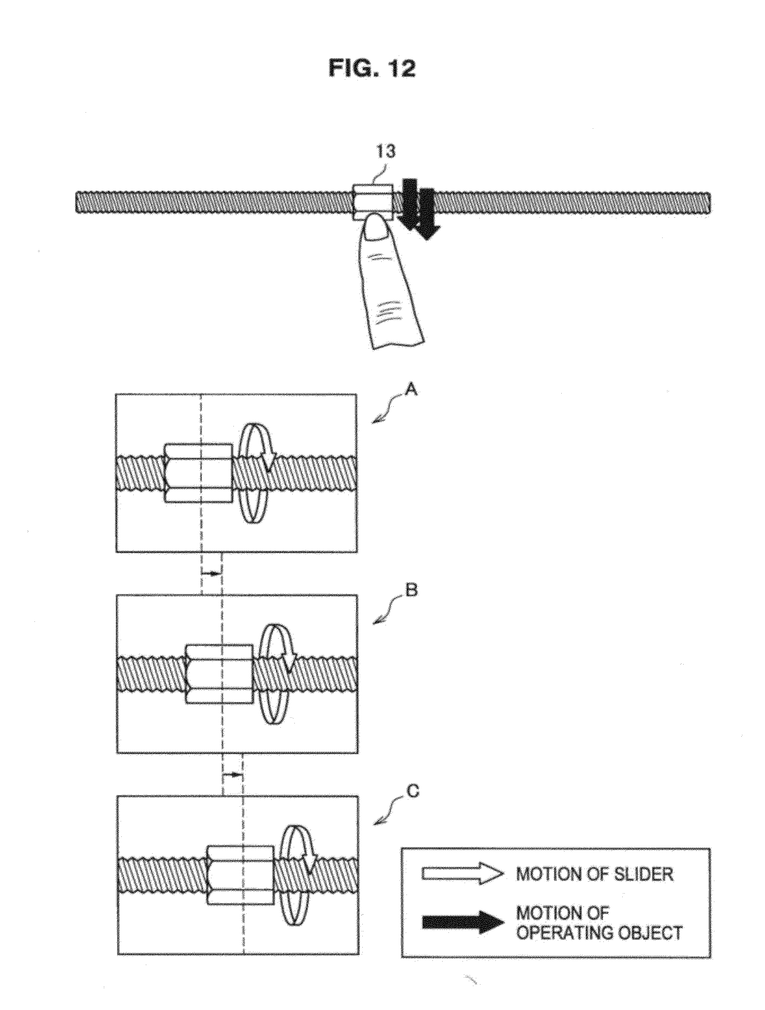

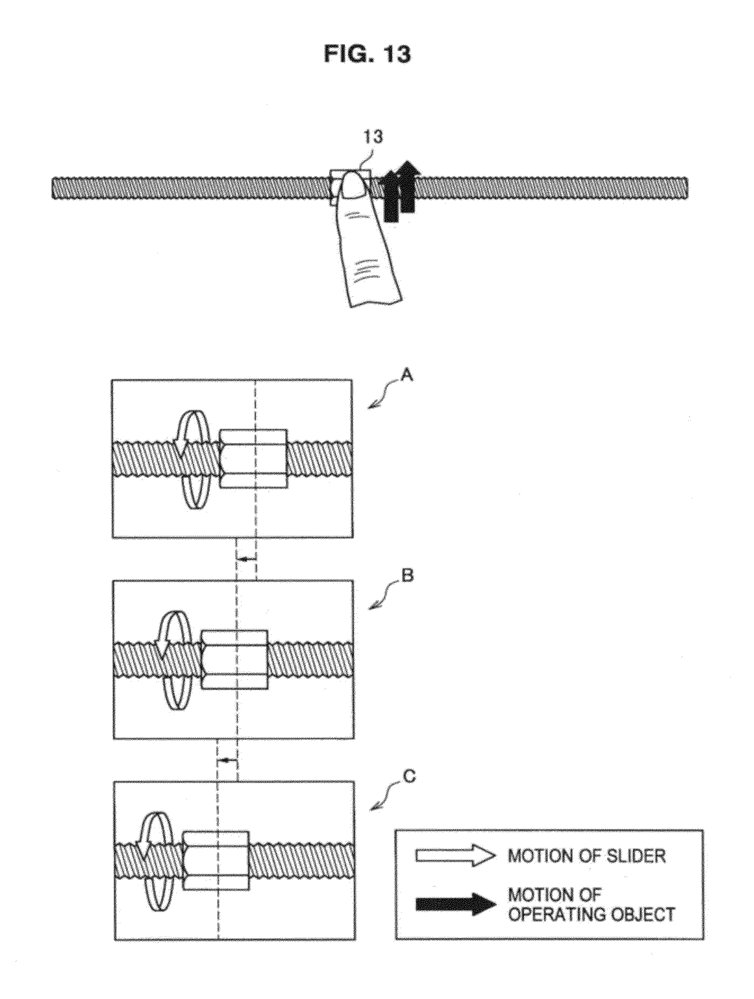

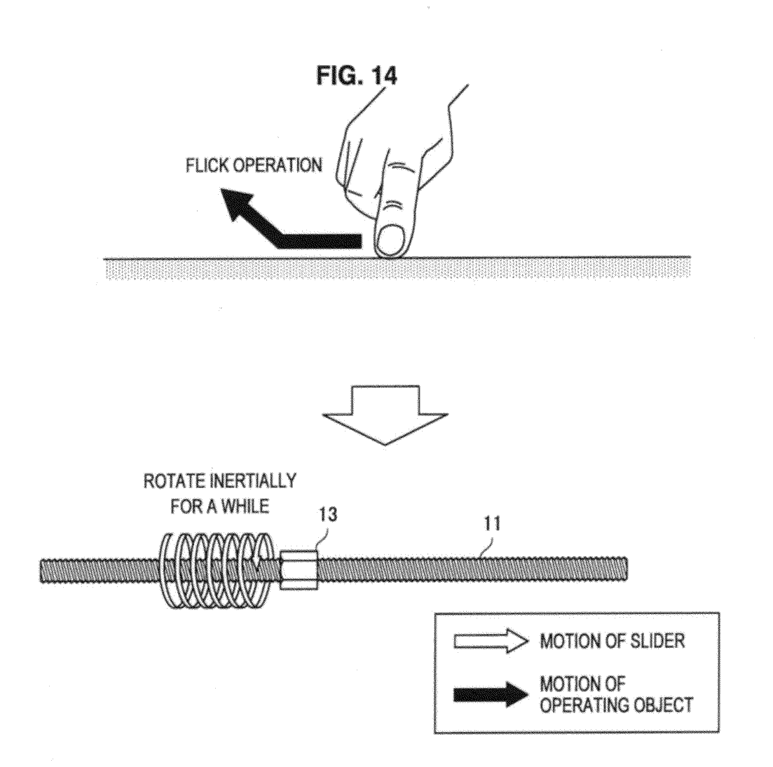

Next, with reference to FIGS. 9 to 14, there will be described examples of action on an occasion of fine adjustment operation, which is a second operation performed to the adjustment bar 10 included in the display screen of the information processing apparatus 100 according to an embodiment of the present disclosure. FIG. 9 is an explanatory diagram illustrating an example of a shape and variations in the shape of the adjustment bar displayed by the information processing apparatus according to the embodiment. FIG. 10 is an explanatory diagram showing another example of the shape of the adjustment bar displayed by the information processing apparatus according to the embodiment. FIG. 11 is an explanatory diagram showing schematically a second operation performed to the adjustment bar displayed by the information processing apparatus according to the embodiment and a motion of the adjustment bar on that occasion. FIG. 12 is an explanatory diagram illustrating a rightward fine adjustment operation performed to the adjustment bar displayed by the information processing apparatus according to the embodiment. FIG. 13 is an explanatory diagram illustrating a leftward fine adjustment operation performed to the adjustment bar displayed by the information processing apparatus according to the embodiment. FIG. 14 is an explanatory diagram illustrating an action executed when a flick operation is performed to the adjustment bar displayed by the information processing apparatus according to the embodiment.

The operation detection section 101 can detect the second operation that has a different motion from that of the first operation. Then, based on the detected second operation, an adjustment section of the playback control section 103 can adjust a current value of a parameter on the basis of a second adjustment unit, which is finer than a first adjustment unit of the first operation. In the case where the operation detection section 101 can detect the second operation, a display control section of the playback control section 103 may notify the user that the second operation can be used by changing the appearance of the adjustment bar 10.

For example, as shown in A of FIG. 9, after changing the position of the slider 13 by performing the first operation, the user releases his/her hand from the screen. Then, the playback control section 103 can notify the user that the second operation can be used, by causing the adjustment bar 10 having an appearance as shown in B of FIG. 9 to be displayed. The adjustment bar 10 shown in B of FIG. 9 is represented by the bar 11 having the shape of a male screw and the slider 13 having the shape of a female screw. Further, the appearance of the adjustment bar 10 to be displayed here may be any of an adjustment bar 10A, an adjustment bar 10B, and an adjustment bar 10C, which are shown in FIG. 10. It is desirable that the appearance of the adjustment bar 10 in the state of being able to perform the second operation be displayed in three dimensions. Note that, although here the operation detection section 101 is in a state of being able to detect the second operation when the termination of the first operation is detected, the present technology is not limited to such an example. For example, the operation detection section 101 may be switched to the state of being able to detect the second operation by operating a predetermined position within the display screen.

Next, with reference to FIG. 11, there will be described an outline of the fine adjustment operation performed to the adjustment bar 10 displayed by the information processing apparatus according to the present embodiment. Here, the second operation performed to the adjustment bar 10 is an operation of touching the adjustment bar 10 in a top-to-bottom or bottom-to-top manner. The second operation has a different motion from that of the first operation. The second operation is an operation for making a fine adjustment of the position of the slider 13. Here, the bar 11 is represented by the shape of the male screw (bolt). Further, the slider 13 is represented by the shape of the female screw (nut). When rotating the slider 13, it moves little by little to the left and right like the nut attached to the bolt. Like the bolt and nut, a large operation of rotation is converted into a small action of left/right fine movement.

Next, with reference to FIG. 12 and FIG. 13, there will be described the fine adjustment operation, which is the second operation, performed to the adjustment bar 10. For example, an operation of touching the adjustment bar 10 in a top-to-bottom manner as shown in FIG. 12 is performed. Then, the state of the slider 13 sequentially changes as shown in A, B, and C of FIG. 12. That is, the slider 13 rotates in accordance with the second operation, and also, the position thereof in the left/right direction finely moves to the right. Further, an operation of touching the adjustment bar 10 in a bottom-to-top manner as shown in FIG. 13 is performed. Then, the state of the slider 13 sequentially changes as shown in A, B, and C of FIG. 13. That is, the slider 13 rotates in accordance with the second operation, and also, the position thereof in the left/right direction finely moves to the left.

Let us assume that the second adjustment unit of the second operation is sufficiently smaller than the first adjustment unit of the first operation. For example, it is preferred that the second adjustment unit be one frame. For example, the playback control section 103 may determine the change in the playback position per rotation of the adjustment bar 10 based on the frame rate. For example, in the case where the frame rate is 60 fps, if the change in the playback position is set to one frame (i.e., 1/60 second) for every 6-degree rotation, the change in the playback position is one second per rotation of the adjustment bar 10.

Next, with reference to FIG. 14, there will be described an action executed when a flick operation is performed to the adjustment bar 10. The flick operation is an operation method used for a device equipped with a touch sensor, and represents an operation of lightly sweeping with an operating object. When detecting the flick operation as the second operation, the operation detection section 101 controls the display of the display screen such that the adjustment bar 10 rotates with acceleration, and such that, after inertially rotating, the adjustment bar 10 comes to a stop after the rotation thereof gradually slows down. In the case where another operation is performed during the inertial rotation, this operation may have priority.

In this way, the accelerated rotation is performed by the flick operation, and accordingly, in the case where the user wants to move the position of the slider 13 largely to some extent in the stage of fine adjustment, the large movement to some extent can be performed by an easy operation.

(2-4. Examples of Operation Area in which Fine Adjustment Operation is Detected)

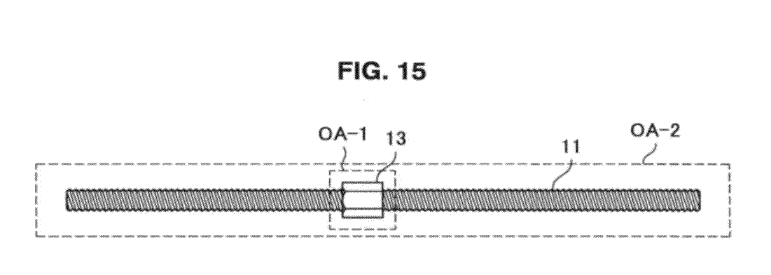

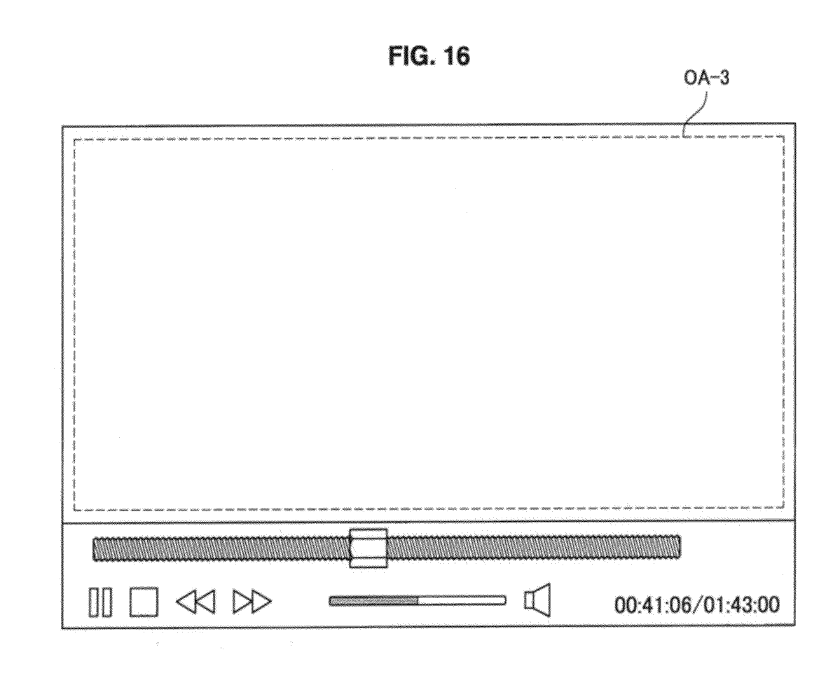

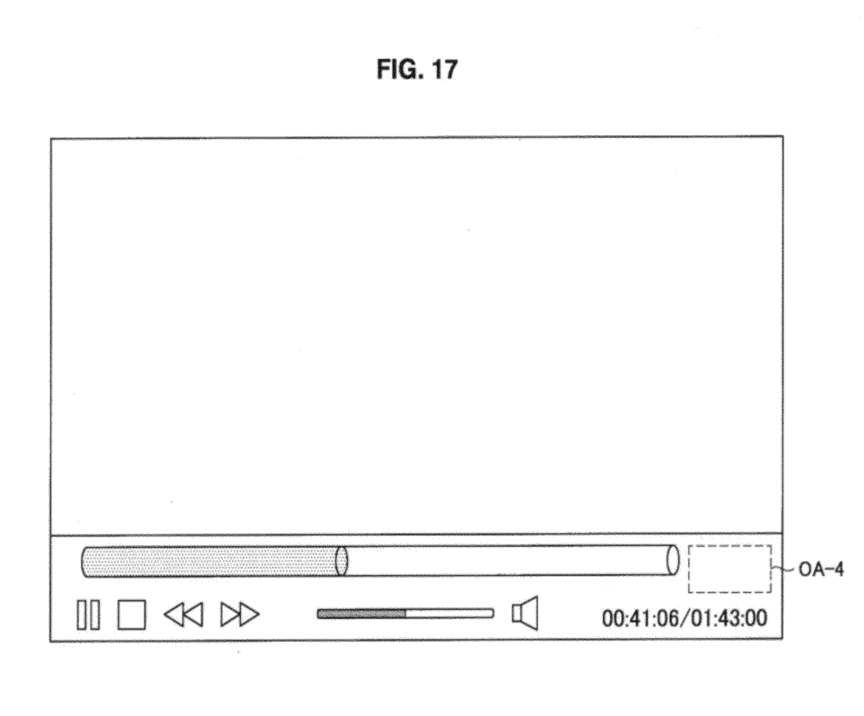

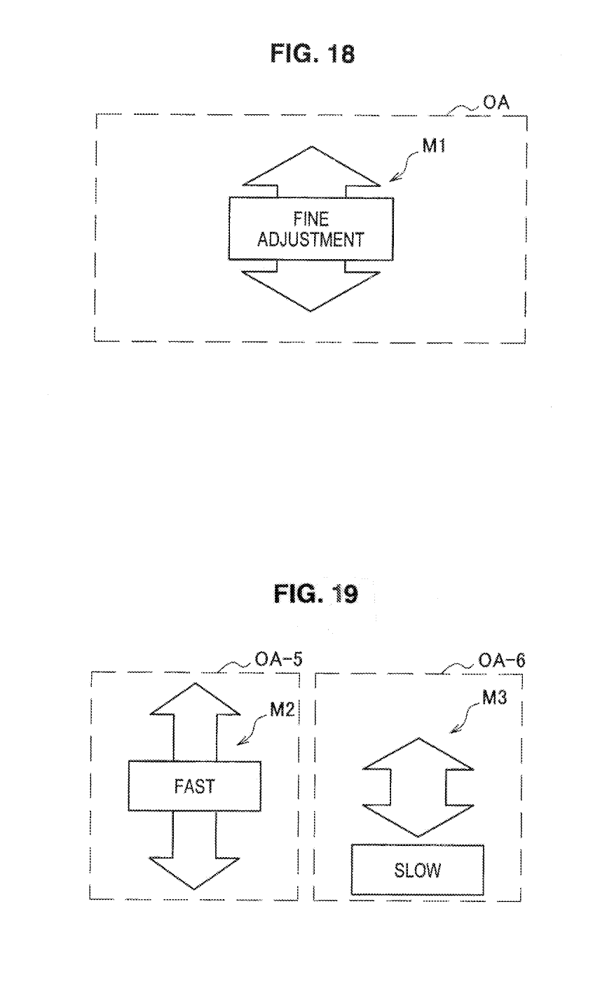

Next, with reference to FIGS. 15 to 19, there will be described operation areas in which fine adjustment operation performed to the adjustment bar 10 is detected, the adjustment bar 10 being displayed by the information processing apparatus 100 according to an embodiment of the present disclosure. FIG. 15 is an explanatory diagram showing an example of an operation area in which a fine adjustment operation performed to the adjustment bar is detected, the adjustment bar being displayed by the information processing apparatus according to the embodiment. FIG. 16 is an explanatory diagram showing another example of the operation area in which the fine adjustment operation performed to the adjustment bar is detected, the adjustment bar being displayed by the information processing apparatus according to the embodiment. FIG. 17 is an explanatory diagram showing another example of the operation area in which the fine adjustment operation performed to the adjustment bar is detected, the adjustment bar being displayed by the information processing apparatus according to the embodiment. FIG. 18 is an explanatory diagram showing an example of a display to be displayed in the operation area for the fine adjustment operation of the adjustment bar displayed by the information processing apparatus according to the embodiment. FIG. 19 is an explanatory diagram showing an example of a display to be displayed in the operation area for the fine adjustment operation of the adjustment bar displayed by the information processing apparatus according to the embodiment.

Referring to FIG. 15, there is shown an example of an operation area OA in which the second operation is detected. As is shown here, the operation area OA in which the second operation is detected may be an operation area OA-1, which represents an area around the slider 13. Further, the operation area OA in which the second operation is detected may be an operation area OA-2, which represents an area around the bar 11.

Further, referring to FIG. 16, another example of the operation area OA in which the second operation is detected. As is shown here, the operation area OA in which the second operation is detected may be an operation area OA-3 on the display area for displaying content. In the case where an operation area with respect to an operation that is different from the second operation is defined in the periphery of the adjustment bar 10, it is difficult for the operation detection section 101 to determine which operation the user intends to perform. Accordingly, the operation area in which the second operation is detected may be set purposely to an area that is placed far away from the adjustment bar 10. For example, as is shown in FIG. 17, the operation area OA in which the second operation is detected may be an area OA-4 that is placed within the display screen and is not used for another operation.

The operation area OA may be set in many ways taking into consideration the layout and usability of the display screen. Further, various methods may be used for notifying the user that it is the operation area OA. For example, while the operation detection section 101 is in the state of being able to detect the second operation, the playback control section 103 can display a mark M for persuading the user to perform the second operation to the part corresponding to the operation area OA, in order to persuade the user into performing the second operation. For example, as shown in FIG. 18, the mark M may be a mark M1 which shows characters indicating that fine adjustment can be carried out and operation directions. The mark M may be always displayed whenever it is in the state of being able to detect the second operation. Alternatively, the mark M may be displayed only during a predetermined time period for the user to learn the operation method.

Further, with regard to the operation area OA in which the second operation is detected, multiple operation areas OA may be included within one display screen, the multiple operation areas OA each having a different combination of an amount of motion of the second operation and an amount of change of parameter from one another. For example, referring to FIG. 19, a mark M2 and a mark M3 are shown. The information processing apparatus 100 may set two operation areas OA, that is, an operation area OA-5 and an operation area OA-6, within the display screen. Within the operation area OA, the mark M2 and the mark M3 indicating characteristics of the operation areas may be displayed. Let us assume that the user performs the second operation in the same motion amount to the operation area OA-5 and to the operation area OA-6. The amount that the parameter changes on this occasion is larger in the second operation performed to the operation area OA-5. According to such a configuration, the user can change the parameter at different speed for each operation area OA.

<3. Conclusion>

As described above, according to the information processing apparatus 100 of the present embodiment, the parameter indicated by the adjustment bar 10 can be changed on the basis of a unit finer than the unit of the adjustment for the first operation of moving the slider 13 of the adjustment bar 10 to the left and right. For example, when the adjustment unit of the adjustment bar 10 for indicating the playback position of the moving image is set to one frame, the user can make an adjustment on a per-frame basis, only with an intuitive operation. For example, it is suitable in the case where the size of the screen used for the operation is limited, such as a mobile terminal which accepts an operation using a touch sensor.

In this case, the second operation for a fine adjustment may be an operation including upward/downward motion, for example. By making the direction of the motion of the first operation different from the direction of the motion of the second operation, the accuracy of detecting, by the information processing apparatus 100, the difference between the first operation and the second operation is improved. Further, by causing the entire or a part of the adjustment bar 10 to rotate in accordance with the second operation, even in the case where the change in the left/right position of the slider 13 is slight, it is possible to notify, by means of the senses, the user that it is during adjustment. In this case, the appearance of the adjustment bar 10 is displayed in the three-dimensional shape, and thus, it becomes possible to express that the adjustment bar 10 is rotating in an easy-to-understand way.

In addition, by changing the appearance of the adjustment bar 10 while the information processing apparatus 100 is in the state of being able to detect the second operation, the user can recognize the time at which the second operation for the fine adjustment can be performed. Further, the information processing apparatus 100 may make a display of showing the state of being able to detect the second operation while the information processing apparatus 100 is in the state of being able to detect the second operation.

It should be understood by those skilled in the art that various modifications, combinations, sub-combinations and alterations may occur depending on design requirements and other factors insofar as they are within the scope of the appended claims or the equivalents thereof

For example, in the embodiment described above, the adjustment bar is changed to the three-dimensional adjustment bar while the second operation can be detected, but the present technology is not limited to such an example. For example, the appearance of the adjustment bar may have a three-dimensional shape from the start.

Further, in the embodiment described above, the second operation in the function of playing back content has been described, but the present technology is not limited to such an example. The function of the playback control section may be implemented as one of the functions of an editing section which edits content, for example. The editing section can edit the content using a predetermined parameter which has been adjusted by a function of the adjustment section. For example, when the editing section performs a processing of cutting a part of the content, if the playback position having the parameter adjusted using the second operation is used, the user can perform the editing without leaving redundant frames remained at the start edge and the end edge of the cut content in the way the user wants with an intuitive operation.

Note that, in the embodiment described above, the operation using the touch sensor has been described, but the present technology is not limited to such an example. The present technology can also be applied to an information processing apparatus which detects operation information by analyzing an image using, for example, an external pointing device such as a mouse, an arrow key, and an imaging device. In this case, for example, in the case where a mouse is used as the input device, the first operation may be performed by a leftward/rightward drag operation. Additionally, in this case, the second operation may be performed by an upward/downward drag operation. Further, in the case of accelerating the rotation, a flick operation performed by a mouse cursor can be used. Still further, in the case where an arrow key is used as the input device, the first operation may be performed by pressing a left/right key. In this case, the second operation may be performed by pressing an up/down key. For example, 6 degree-rotation can be performed each time the key is pressed. In the case of accelerating the rotation, an up/down key-long-pressing operation can be used.

Additionally, the present technology may also be configured as below.
(1) An apparatus including:

a display control unit configured to control a display unit to display content including a plurality of images and an adjustment bar having a slider that controls a current image of the content displayed on the display unit, the slider being moved by a first operation and a second operation, the second operation changing a position of the slider with a finer adjustment than the first operation.
(2) The apparatus according to (1), wherein the first operation is a drag operation of the slider.
(3) The apparatus according to (1) or (2), wherein the second operation is a rotation operation of the slider around an axis of the adjustment bar.
(4) The apparatus according to (3), wherein the slider moves along the axis of the adjustment bar when the slider is rotated around the axis of the adjustment bar.
(5) The apparatus according to one of (1) to (4), wherein the display control unit controls the display unit to display the slider as a nut and the adjustment bar as a threaded bolt.
(6) The apparatus according to one of (1) to (5), wherein the display control unit controls the display unit to display the adjustment bar as a three-dimensional object.
(7) The apparatus according to one of (1) to (6), wherein the display control unit controls the display to change the display of the adjustment bar at a beginning of the second operation.
(8) The apparatus according to (7), wherein the display control unit controls the display unit to change the display of the adjustment bar at an end of the first operation.
(9) The apparatus according to (7), wherein the display control unit controls the display unit to display the adjustment bar as a three-dimensional object and the display control unit controls the display unit to change the display of the adjustment bar.
(10) The apparatus according to one of (1) to (7), wherein the display control unit controls the display unit to change the display of the slider and the adjustment bar such that the slider is a first icon and the adjustment bar is a smooth rod only during the first operation, and the slider is a nut and the adjustment bar is a threaded bolt when the first operation is not being performed.
(11) The apparatus according to one of (1) to (10), wherein the display control unit controls the display unit to continue to rotate the slider inertially after a flick operation is performed on the slider during the second operation.
(12) The apparatus according to one of (1) to (11), wherein the display control unit controls the display unit to display the slider with respect to the adjustment bar at a location corresponding to a current playback position with respect to a full length of the content.
(13) The apparatus according to one of (1) to (12), wherein the display control unit controls the display unit to change a playback position of the content by one frame as an adjustment unit for the second operation.
(14) The apparatus according to one of (1) to (13), wherein the display control unit controls the display unit to display a volume adjustment bar, the volume adjustment bar including a volume level portion indicating the current volume level which is a different color than a rest of the volume adjustment bar.
(15) The apparatus according to one of (1) to (14), wherein the display control unit controls the display unit to display a first icon which indicates that the second operation can be performed for fine adjustment of a current playback position of the content.
(16) The apparatus according to (15), wherein the display control unit controls the display unit to display the first icon in an operation area in which the second operation can be performed.
(17) The apparatus according to (15), wherein the display control unit controls the display unit to display a second icon which indicates that the second operation can be performed for fine adjustment of the current playback position of the content at a different speed than a speed of adjustment for the first icon.
(18) A content editing apparatus including the apparatus according to (1).
(19) A method including:

controlling a display unit to display content including a plurality of images and an adjustment bar having a slider that controls a current image of the content displayed on the display, the slider being moved by a first operation and a second operation, the second operation changing a position of the slider with a finer adjustment than the first operation.
(20) A non-transitory computer readable medium encoded with a program that, when loaded on a processor, causes the processor to perform a method including:

controlling a display unit to display content including a plurality of images and an adjustment bar having a slider that controls a current image of the content displayed on the display, the slider being moved by a first operation and a second operation, the second operation changing a position of the slider with a finer adjustment than the first operation.

Furthermore, the present technology may also be configured as below.
(1) An information processing apparatus including:

a display control section which controls a display of a display screen including an adjustment bar which relatively indicates a current value of a predetermined parameter with respect to a full amount, using a position of a slider on a bar;

a detection section which detects an operation input to the display screen; and

an adjustment section which adjusts the current value of the predetermined parameter based on a second operation that has a different motion from a motion of the first operation of specifying the position of the slider, on a basis of a second adjustment unit, which is finer than a first adjustment unit of the first operation.
(2) The information processing apparatus according to (1),

wherein the display control section controls the display of the display screen in a manner that the adjustment bar rotates in accordance with the second operation.
(3) The information processing apparatus according to (1) or (2),

wherein the display control section causes a shape of the adjustment bar to be displayed three-dimensionally.
(4) The information processing apparatus according to any one of (1) to (3),

wherein, while the detection section is able to detect the second operation, the display control section changes an appearance of the adjustment bar.
(5) The information processing apparatus according to (4),

wherein the display control section causes a shape of the adjustment bar to be displayed three-dimensionally, and thus changes the appearance of the adjustment bar.
(6) The information processing apparatus according to (4) or (5),

wherein, when the detection section detects termination of the first operation, the display control section changes the appearance of the adjustment bar.
(7) The information processing apparatus according to (2),

wherein the second operation includes a flick operation, and

wherein, when detecting the flick operation, the display control section inertially rotates the adjustment bar with acceleration.
(8) The information processing apparatus according to any one of (1) to (7),

wherein the predetermined parameter is a playback position of content played back in the display screen.
(9) The information processing apparatus according to (8),

wherein the second adjustment unit represents one frame.
(10) The information processing apparatus according to any one of (1) to (8),

wherein the predetermined parameter is a volume at which played back content is output.
(11) The information processing apparatus according to (9) or (10), further including:

an editing section which edits the content using the predetermined parameter adjusted by the adjustment section.
(12) The information processing apparatus according to any one of (1) to (11),

wherein the bar has a shape of a male screw, and

wherein the slider has a shape of a female screw.
(13) The information processing apparatus according to any one of (1) to (12),

wherein, while the detection section is able to detect the second operation, the display control section causes a display for persuading a user to perform the second operation to be displayed on the display screen.
(14) The information processing apparatus according to (13),

wherein the display for persuading a user to perform the second operation is shown together with an operation area in which the second operation is detected.
(15) The information processing apparatus according to any one of (1) to (14),

wherein the display screen includes a plurality of operation areas each having a different combination of an amount of the motion of the second operation and an amount of change of the parameter from one another.
(16) An information processing method including:

controlling a display of a display screen including an adjustment bar which relatively indicates a current value of a predetermined parameter with respect to a full amount, using a position of a slider on a bar;

detecting an operation input to the display screen; and

adjusting the current value of the predetermined parameter based on a second operation that has a different motion from a motion of the first operation of specifying the position of the slider, on a basis of a second adjustment unit, which is finer than a first adjustment unit of the first operation.
(17) A program for causing a computer to function as an information processing apparatus including

a display control section which controls a display of a display screen including an adjustment bar which relatively indicates a current value of a predetermined parameter with respect to a full amount, using a position of a slider on a bar,

a detection section which detects an operation input to the display screen, and

an adjustment section which adjusts the current value of the predetermined parameter based on a second operation that has a different motion from a motion of the first operation of specifying the position of the slider, on a basis of a second adjustment unit, which is finer than a first adjustment unit of the first operation.

What is claimed is:

1. An apparatus comprising:
a display control unit configured to control a display unit to display content including a plurality of images and an adjustment bar having a slider that controls a current image of the content displayed on the display unit, the slider being moved by a first operation and a second operation, the second operation changing a position of the slider with a finer adjustment than the first operation.

2. The apparatus according to claim 1, wherein the first operation is a drag operation of the slider.

3. The apparatus according to claim 1, wherein the second operation is a rotation operation of the slider around an axis of the adjustment bar.

4. The apparatus according to claim 3, wherein the slider moves along the axis of the adjustment bar when the slider is rotated around the axis of the adjustment bar.

5. The apparatus according to claim 4, wherein the display control unit controls the display unit to display the slider as a nut and the adjustment bar as a threaded bolt.

6. The apparatus according to claim 1, wherein the display control unit controls the display unit to display the adjustment bar as a three-dimensional object.

7. The apparatus according to claim 1, wherein the display control unit controls the display to change the display of the adjustment bar at a beginning of the second operation.

8. The apparatus according to claim 7, wherein the display control unit controls the display unit to change the display of the adjustment bar at an end of the first operation.

9. The apparatus according to claim 7, wherein the display control unit controls the display unit to display the adjustment bar as a three-dimensional object and the display control unit controls the display unit to change the display of the adjustment bar.

10. The apparatus according to claim 1, wherein the display control unit controls the display unit to change the display of the slider and the adjustment bar such that the slider is a first icon and the adjustment bar is a smooth rod only during the first operation, and the slider is a nut and the adjustment bar is a threaded bolt when the first operation is not being performed.

11. The apparatus according to claim 1, wherein the display control unit controls the display unit to continue to rotate the slider inertially after a flick operation is performed on the slider during the second operation.

12. The apparatus according to claim 1, wherein the display control unit controls the display unit to display the slider with respect to the adjustment bar at a location corresponding to a current playback position with respect to a full length of the content.

13. The apparatus according to claim 1, wherein the display control unit controls the display unit to change a playback position of the content by one frame as an adjustment unit for the second operation.

14. The apparatus according to claim 1, wherein the display control unit controls the display unit to display a volume adjustment bar, the volume adjustment bar including a volume level portion indicating the current volume level which is a different color than a rest of the volume adjustment bar.

15. The apparatus according to claim 1, wherein the display control unit controls the display unit to display a first icon which indicates that the second operation can be performed for fine adjustment of a current playback position of the content.

16. The apparatus according to claim 15, wherein the display control unit controls the display unit to display the first icon in an operation area in which the second operation can be performed.

17. The apparatus according to claim 15, wherein the display control unit controls the display unit to display a second icon which indicates that the second operation can be performed for fine adjustment of the current playback position of the content at a different speed than a speed of adjustment for the first icon.

18. A content editing apparatus including the apparatus according to claim 1.

19. A method comprising:
controlling a display unit to display content including a plurality of images and an adjustment bar having a slider that controls a current image of the content displayed on the display, the slider being moved by a first operation and a second operation, the second operation changing a position of the slider with a finer adjustment than the first operation.

20. A non-transitory computer readable medium encoded with a program that, when loaded on a processor, causes the processor to perform a method comprising:
controlling a display unit to display content including a plurality of images and an adjustment bar having a slider that controls a current image of the content displayed on the display, the slider being moved by a first operation and a second operation, the second operation changing a position of the slider with a finer adjustment than the first operation.
